(19) United States
(12) Patent Application Publication
(10) Pub. No.: US 2011/0251971 A1
(43) Pub. Date: Oct. 13, 2011

(54) SYSTEM AND METHOD FOR FACILITATING REAL-TIME COLLABORATION IN A CUSTOMER SUPPORT ENVIRONMENT

(75) Inventors: Timothy J. Bethea, Sunnyvale, CA (US); Neil H. Boyette, Oregon City, OR (US); Isaac K. Cheng, San Jose, CA (US); Vikas Krishna, San Jose, CA (US); Yolanda A. Rankin, San Jose, CA (US); Yongshin Yu, San Jose, CA (US)

(73) Assignee: International Business Machines Corporation, Armonk, NY (US)

(21) Appl. No.: 12/756,813

(22) Filed: Apr. 8, 2010

(51) Int. Cl. G06Q 99/00; G06F 17/27; G06F 9/445; G06Q 10/00; G06F 15/16

(52) U.S. Cl. 705/319; 709/204; 717/176; 704/9; 704/E15.043

(57) ABSTRACT

An embodiment of the invention comprises a real-time collaborative technical support (RTCTS) system that may automatically generate and/or maintain social networks that may be dynamically evolving. The social networks may be based on the output of at least one multi-modal classification algorithm. These outputs may be occurring in real-time.

### BACKGROUND OF THE INVENTION

1. Field of the Invention

The present invention relates to software and systems used in data centers, call centers and/or customer support applications.

2. Background Information

By way of background, in a customer call center or other support setting there are often tens, hundreds or even thousands of people working with customers simultaneously, each trying to solve their particular customer's issues. How well and how quick each customer's problem is solved depends greatly on the experience of the support person. A customer who gets a novice support person will spend longer amounts of time trying to solve the problem which translates into higher support costs, lower customer satisfaction and a higher probability for escalation which increases costs.

Existing solutions allow customer support people to utilize a knowledge base to look up common (generic) solutions based on the information provided by the customer. However, this solution is only beneficial when customer support people rely on their previous experience to select the appropriate keywords to search for possible solutions. If the support person is unable to resolve the customer's problem, the problem is escalated to a higher level of customer support, resulting in increasing costs.

Therefore, there exists a need in the art for an apparatus and methods that can provide the higher level of customer support without increasing costs.

### SUMMARY OF THE INVENTION

The foregoing problems are solved and an advance in the art is obtained by a novel method, system and computer program product for a real-time collaborative technical support (RTCTS) system.

The system may include means for facilitating collaboration in a real-time support provider environment of at least two support people with the support provider environment, that may include the following: Means for combining at least two of the support people into a temporary group concerned supporting a related work area of the support people. Means for forming-maintaining at least one social network based upon the temporary group to support requests in the related work area. And means for providing a visualization of the social network.

The means for combining may include at least one monitor of the support people to determine a work area that at least two of the support people share to create the related work area.

The means for forming-maintaining the social network may include means for generating the social network based upon available data, means for evolving the social network based upon the available information and/or means for altering the social network based upon the available information.

The available information may include at least one instance of at least one member of the data type group consisting of structured information, unstructured information, raw data, derived data and historical data.

The system may further include at least one of means for updating by at least one of the support people of the available information and means for processing by at least one monitor of at least one instance of at least one member of the data type group to create/update the available information.

The means for processing by the monitor further comprises at least one of the following: At least one natural language processor responding to at least one instance of at least one member of the data type group to at least partly create the available information. And/or at least one speech to text processor responding to at least one instance of at least one member of the data type group to at least partly create the available information. And/or a data aggregator responding to at least part of the available information to send at least part of the available information to at least one of the natural language processor, the speech to text processor and a classification system.

The means for forming-maintaining the social network may further include the classification system classifying at least part of the available data to generate the social network and/or the classification system classifying at least part of the available data to stimulate the social network to evolve.

The visualization of the social network may use at least one grouping of the support people based upon at least one estimate of the support people, with the estimate relating to a support person's ability to discern a customer's meaning, efficiency in solving a problem, ability to use at least one available tool and/or ability to articulate a solution of the problem.

The social network for the support people provides at least one classification, such as of which of the support people are currently working in the related work area, which of the support people have previous experience with the related work area and which of the support people are experts in the related work area.

The social network visualization may be received by a means for inserting the expert into the social network for the related work area.

One method may include a step of facilitating collaboration in a real-time support provider environment of at least two support people with the support provider environment, that may include the following steps: Combining at least two of the support people into a temporary group concerned supporting a related work area of the support people. Forming-maintaining at least one social network based upon the temporary group to support requests in the related work area. And providing a visualization of the social network.

The step of combining may include monitoring the support people to determine a work area that the at least two of the support people share to create the related work area.

The step of forming-maintaining the social network may include evolving the social network based upon available information, generating the social network based upon the available information, and/or altering the social network based upon the available information.

The method may further include updating by at least one of the support people the available information and/or processing by the monitor of at least one instance of at least one member of the data type group to create/update the available information.

The step of processing by the monitor may include steps of processing by at least one natural language processor to at least partly create the available information, processing by at least one speech to text processor to at least partly create the available information, and/or determining by a data aggregator to send at least part of the available information to at least one member of the group consisting of the natural language processor, the speech to text processor and a classification system.

The step of forming-maintaining the social network may further include steps of classifying by a classification system at least part of the available data to generate the social network and/or classifying by the classification system the at least part of the available data to stimulate the social network to evolve.

The step of providing the visualization further comprises at least one of the steps providing the visualization to a manager to aid in managing the support provider environment and/or inserting the expert into the social network for the related work area.

A computer readable memory may implement the method as a program system. An installation package may be configured to include the program system to reside in the computer readable memory. A server may be configured to deliver the program system and/or the installation package. And a computer may be configured by the program system and/or the installation package to implement at least part of the method.

### BRIEF DESCRIPTION OF THE DRAWINGS

FIG. 1 illustrates a functional block diagram of an exemplary embodiment of the system in accord with the invention.

FIG. 2 shows the means for combining may include at least one monitor of the support people to determine a work area that the support people share to create the related work area.

FIG. 3 shows some details of the means for forming-maintaining the social network.

FIG. 4 shows some details of the available information.

FIG. 5 shows some details of the system.

FIG. 6 shows some refinements of the means for processing by the monitor of FIG. 5.

FIG. 7 shows the visualization of the social network may use at least one grouping of the support people based upon at least one estimate relating to a support person's abilities.

FIG. 8 shows the social network may provide at least one classification.

FIG. 9 shows the social network visualization may be received by a means for inserting the expert support person into the social network for the related work area.

FIG. 10 shows a function diagram of the system and/or the support provider environment may include a computer and/or a computer readable memory that may contain a program system and/or an installation package, and/or a server configured to communicate with the computer to download the program system and/or the installation package.

And FIGS. 11 to 18 show flowcharts of the program system as an implementation of at least one method embodiment.

### DESCRIPTION OF THE PREFERRED EMBODIMENTS

The foregoing problems are solved and an advance in the art is obtained by a novel method, system and computer program product for a real-time collaborative technical support (RTCTS) system.

An embodiment of the invention comprises a real-time collaborative technical support (RTCTS) system 10 that may automatically generate and/or maintain social networks 80 that may dynamically evolve in real-time.

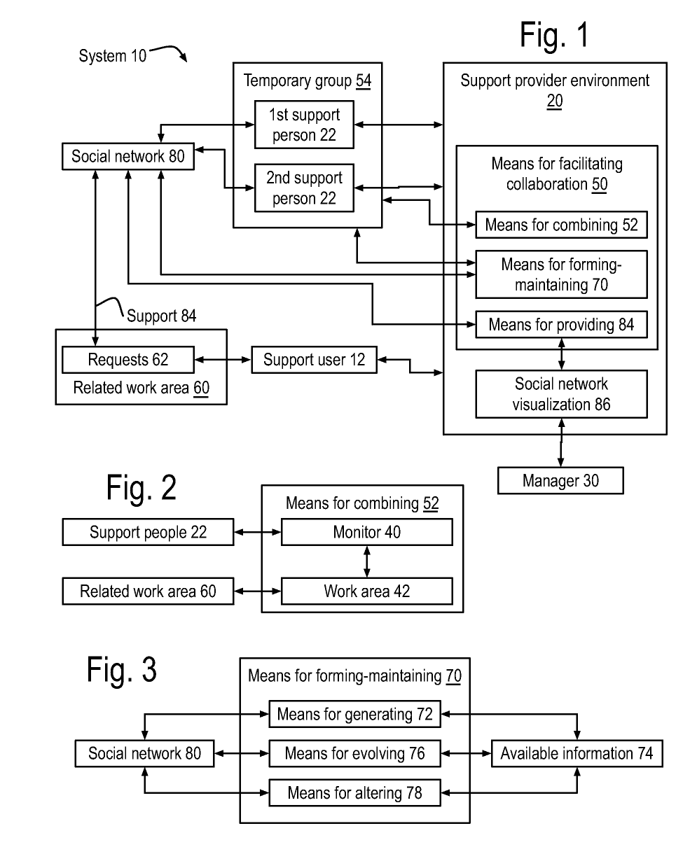

Referring to the drawing figures wherein like reference numerals indicate like components in all of the several views, FIG. 1 illustrates an exemplary embodiment of the system 10 that may include means for facilitating collaboration 50 in a real-time support provider environment 20 of at least two support people 22 with the support provider environment 20, that may include the following: Means for combining 52 at least two of the support people into a temporary group 54 concerned supporting a related work area 60 of the support people. Means for forming-maintaining 70 at least one social network 80 based upon the temporary group 54 to support requests 62 in the related work area 60. And means for providing 84 a visualization 86 of the social network. At least one support user 12 may interact with the support provider environment 20 to create the requests 62. At least one manager 30 may receive the social network visualization 86 as an aid in managing the support provider environment 20 and/or managing at least some of the support people 22.

The RTCTS system 10 transforms customer call centers into social networks 80 that may display otherwise hidden groupings 54 in the support provider environment 20, which may also be referred to as a customer support environment.

FIG. 2 shows the means for combining 52 may include at least one monitor 40 of the support people 22 to determine a work area 42 that the support people 22 share to create the related work area 60.

FIGS. 3 to 5 show these social networks 80 may evolve based on available information 74, which may differ from the current state of the art. This available information 74 may be used to generate and/or alter the social network 80. The available information 74 may include any combination of instances of structured information 100 and/or unstructured information 102. The available information 74 may include raw data 104 and derived data 106 based upon at least part of the raw data and/or may include historical data 108, any combination of which in certain embodiments may include structured information 100 and/or unstructured information 104. These social networks tend to be more accurate and insightful for support users than a single modal view of the same available information.

FIG. 3 shows the means for forming-maintaining 70 the social network 80 may include means for generating 72 the social network based upon available data 74, means for evolving 76 the social network based upon the available information and/or means for altering 78 the social network based upon the available information.

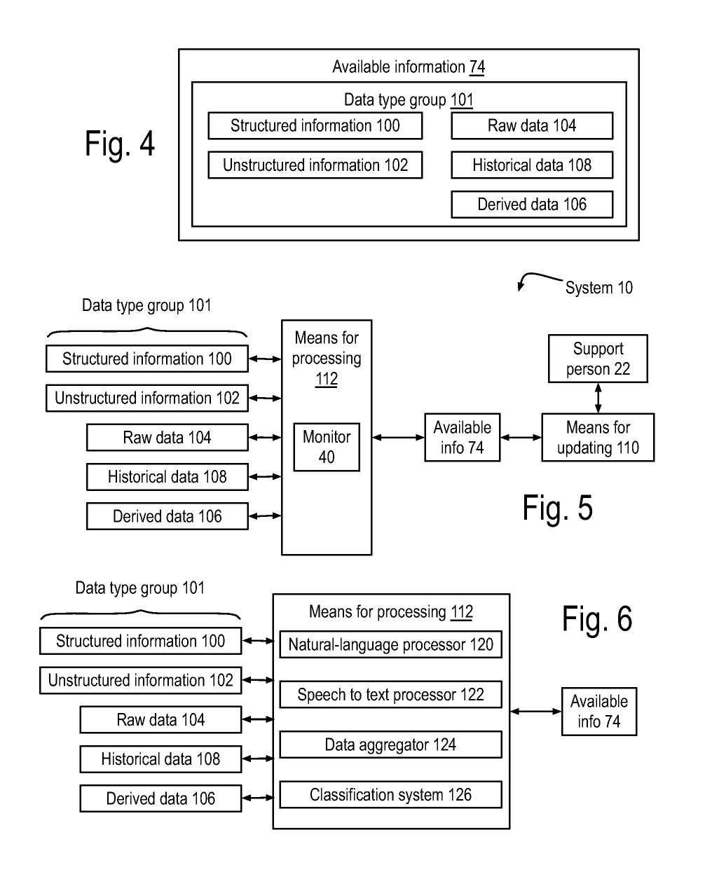

FIG. 4 shows the available information 74 may include at least one instance of at least one member of the data type group 101 consisting of structured information 100, unstructured information 102, raw data 104, derived data 106 and historical data 108.

FIG. 5 shows the system 10 may further include means for updating 110 by at least one of the support people 22 of the available information 74 and/or means for processing 112 by at least one monitor 40 of at least one instance of at least one member 100, 102, 104, 106 and/or 108 of the data type group 101 to create/update the available information.

The RTCTS system 10 may leave it up to the users 12 to update the available information 74 and/or the RTCTS system may use multiple types of monitors 40 that may process structured information 100 and/or unstructured information 102 to create and/or maintain the available information 74 and/or the social networks 80. The monitors 114 may use and/or include natural language processors 120 and/or speech to text software 122. The RTCTS system 10 may direct the raw data 104, the derived data 106 and/or the historical data 108 to be presented to a classification system 126 that generates and/or evolves at least one of the social networks 80.

FIG. 6 shows a refinement of the means for processing 112 by the monitor 40 of FIG. 5 that may further include at least one of the following: At least one natural language processor 120 configured to respond to at least one instance of at least one member 100, 102, 104, 106, and/or 108 of the data type group 76 to at least partly create the available information 74. At least one speech to text processor 122 configured to respond to at least one instance of at least one of the members of the data type group to at least partly create the available information. And/or a data aggregator 124 may be configured to respond to at least part of the available information 74 to send at least part of the available information to the natural language processor 120, the speech to text processor 122 and a classification system 126. The social networks 80 may be based on the output of at least one multi-modal classification algorithm implemented as at least part of the classification system 126.

The means for forming-maintaining 70 may further include the classification system 126 classifying at least part of the available data 74 to generate the social network 80 and/or the classification system 126 classifying the at least part of the available data 74 to stimulate the social network 80 to evolve.

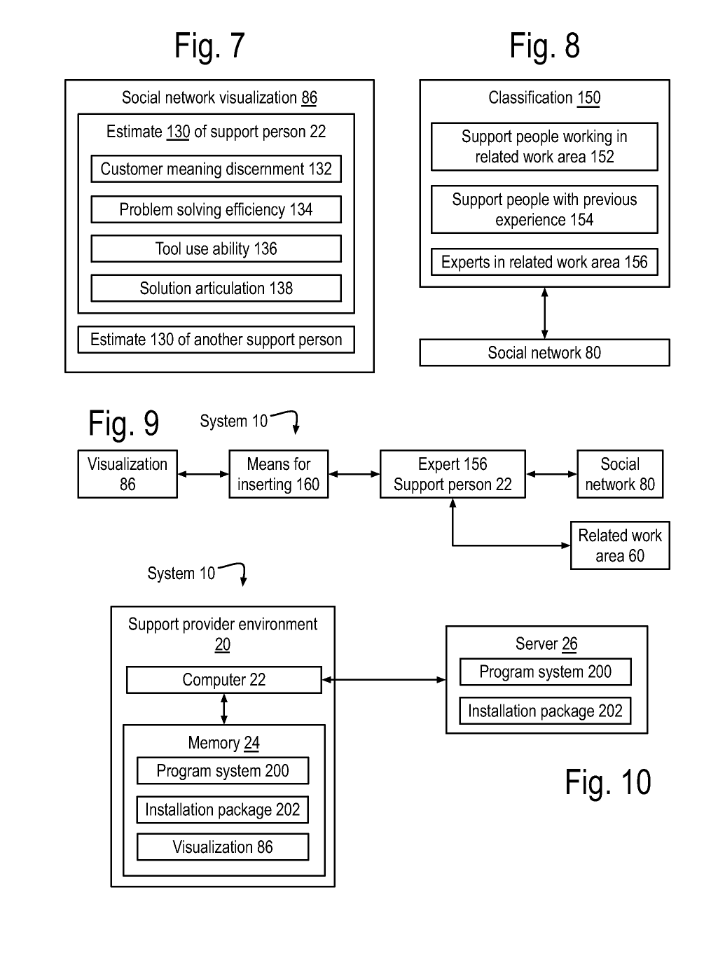

FIG. 7 shows the visualization 86 of the social network 80 may use at least one grouping 54 of the support people 22 based upon at least one estimate 130 of the support people, with the estimate relating to a support person's ability to discern 132 a customer's meaning, problem solving efficiency 134, tool use ability 136 and/or ability to articulate 138 a solution of the problem.

FIG. 8 shows the social network 80 may provide at least one classification 150, such as of which of the support people 22 are currently working 152 in the related work area 22 of FIG. 1, which of the support people have previous experience 154 with the related work area and which of the support people are experts 156 in the related work area.

FIG. 9 shows the social network visualization 86 may be received by a means for inserting 160 one expert 156 support person 22 into the social network 80 for the related work area.

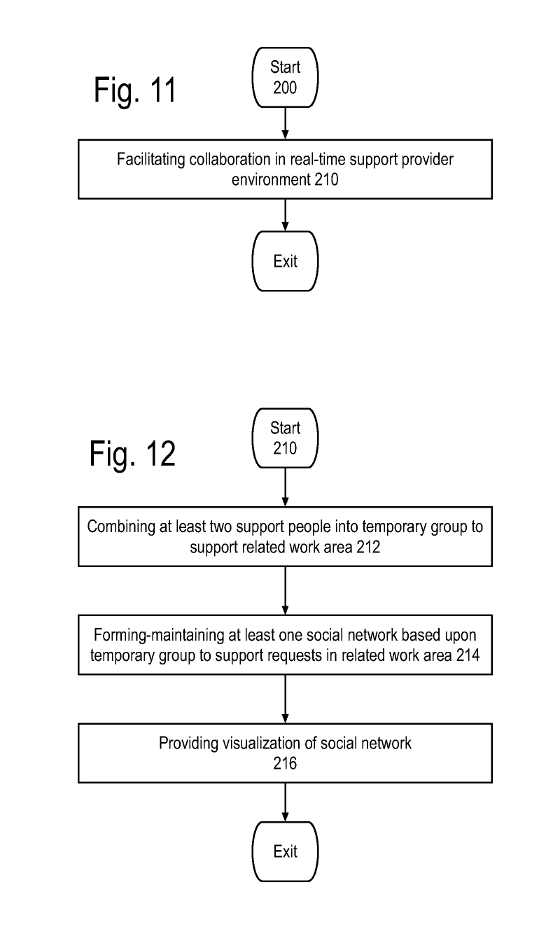

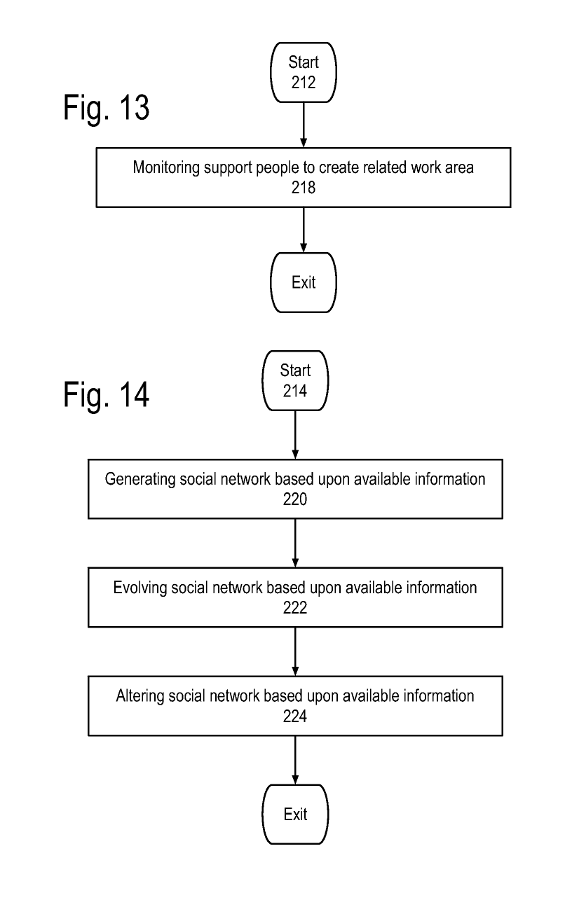

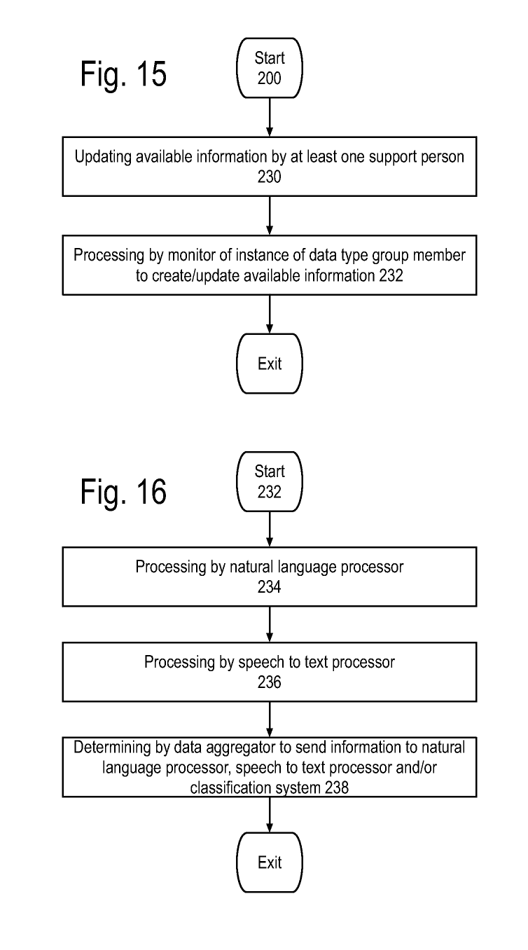

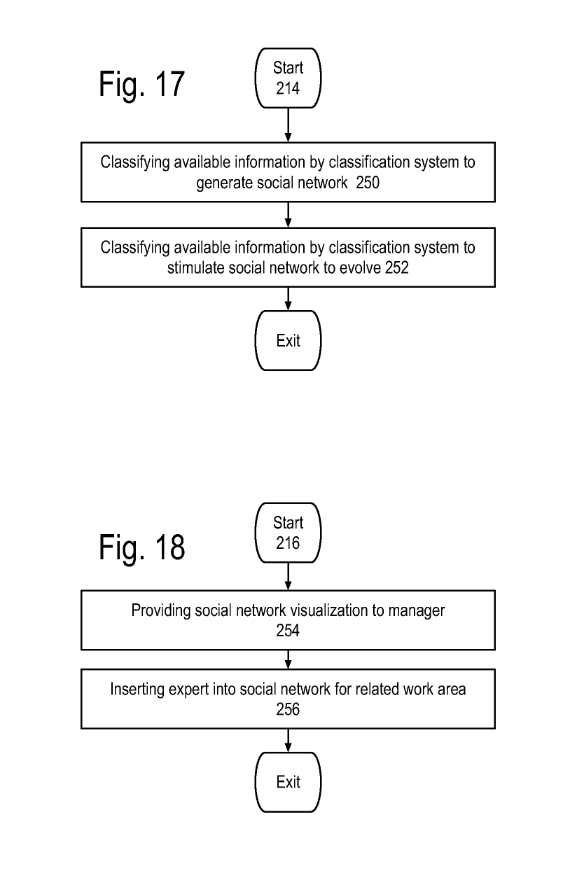

FIG. 10 shows the system 10, in certain embodiments, the support provider environment 20 may include a computer 22 and/or a computer readable memory 24 that may contain a program system 200 that at least in part implements the steps of the method of operating the system 10. Alternatively, the computer readable memory 24 may include an installation package 202 that may be configured to instruct the computer 22 to install at least part of the program system 200. The computer readable memory 24 may include at least one visualization 86 of the social network 80 as previously described. Embodiments of the invention may include a server 26 configured to communicate with the computer 22 to download the program system 200 and/or the installation package 202.

In certain embodiments of the invention any of the means 50, 52, 54, 56, 70, 72, 74, 78, 112, the monitors 40, the natural language processor 120, the speech to text processor 122, the data aggregator 124 and/or the classification system 126 disclosed herein may be implemented using at least one instance of a computer 22.

Referring to the drawing Figures, and particularly, to FIGS. 11 to 18, FIGS. 11 to 18 show flowcharts of the program system 200 as an implementation of one method embodiment.

FIG. 11 shows the program system 200 includes the program instruction 210 facilitating collaboration in a real-time support provider environment 20 of at least two support people 22 with the support provider environment 20.

FIG. 12 shows a refinement of the program instruction 210 of FIG. 11 that may include the following: Program instruction 212 supports combining at least two of the support people 22 into a temporary group 54 to support a related work area 60 of the support people 22. Program instruction 214 supports forming-maintaining at least one social network 80 based upon the temporary group 54 to support requests 62 in the related work area 60. Program instruction 216 supports providing a visualization 86 of the social network 80.

FIG. 13 shows a refinement of program instruction 212 of FIG. 12 that may include program instruction 218 that supports monitoring 40 the support people 22 to determine a work area that the at least two of the support people 22 share to create the related work area 60.

FIG. 14 shows a refinement of program instruction 214 that may include at least one of the following: Program instruction 220 supports generating the social network 80 based upon the available information 74. Program instruction 222 supports evolving the social network 80 based upon available information 74. Program instruction 224 supports altering the social network 80 based upon the available information 74.

FIG. 15 shows the program system 200 of FIG. 11 may further include the following: Program instruction 230 supports updating the available information 74 by at least one of the support people 22. Additionally, or alternatively, program instruction 232 supports processing by the monitor 40 of at least one instance of at least one member of the data type group 101.

FIG. 16 shows a refinement of program instruction 232 of FIG. 15 that may include at least one of the following: Program instruction 234 supports processing by the natural language processor 120. Program instruction 236 supports processing by the speech to text processor 122. Program instruction 238 supports determining by the data aggregator 124 to send at least part of the available information 74 to the natural language processor 120, the speech to text processor 122 and/or the classification system 126.

FIG. 17 shows a refinement of program instruction 214 of FIG. 12 forming-maintaining at least one social network 80 as including at least one of the following: Program instruction 250 supports classifying the available information 74 by the classification system 126 to generate the social network 80. Program instruction 252 supports classifying the available information 74 by the classification system 126 to stimulate the social network 80 to evolve.

FIG. 18 shows a refinement of program instruction 216 of FIG. 12 that may include at least one of the following: Program instruction 254 supports providing the visualization 86 of the social network 80 to the manager. Program instruction 256 supporting inserting the expert 156 support person 22 into the related work area 60.

In further detail, current problems and available experts 156 may be grouped together to facilitate communication between expert and novice Customer Service Representatives (CSRs) 22 while simultaneously resolving customer technical issues in an effective and efficient manner.

The RTCTS system 10 provides management 30 with visualizations 86 of the social networks 80 where they can efficiently observe groupings 54 of support people 22. Consider the following examples: The grouping may be based on estimates of the support person's ability to easily discern 132 a customers meaning, efficiency 134 in solving a problem, and/or ability 136 to use the tools available etc. This may aid the administrator in monitoring the Customer Call Center 20 and allocating resources as needed in the most efficient manner.

The application may include multiple monitors 40 concurrently determining what each support person 22 is working on, which may depend on the context being monitored. Some examples of monitors 40 may watch structured information 100 and/or unstructured information 102 that may include at least one written narrative and/or (possibly real-time) voice recordings. The structured information may include specified fields in the support entry system (i.e. Name, Severity) and/or a voice xml document. The monitors may be operated by or their results may be used by one of the technical support personnel 22.

The data aggregator 124 may group related information (such as by support person 22, organization etc) received as gathered data from at least one of the monitors 40. The gathered data may or may not include personally identifiable data. In certain embodiments, the monitors may send the depersonalized data to a privacy-monitoring server 26.

Based on the type of the gathered information, the data aggregator 124 may send it directly to a classification system 126 as it is received, or pass it though services that may extract and/or otherwise aid in the pre-classification process. Examples of these services include speech to text processors 122 for converting spoken words to text and natural language processors 122 that may aid in determining the meaning of free-form text narratives such as results from speech to text, or from written paragraphs.

The classification system 126 may classify the received information and/or historical data 108 into related clusters that in turn may be used to create at least one new social network 80.

Different types of social networks 80 may be created based upon this information and the related cluster. One example is a social network 80 for support people 22 grouped by problem type to help them solve their current problems. Another example social network 80 is for managers 30 where support people 22 may be grouped based on their problem solving efficiency 134 and/or based on their ability to articulate 138 a problem and so on.

The social networks 80 may be used and/or visualized 86 in a variety of ways, from a simple group chat to a dashboard-like application to a virtual world. These visualizations may be different for support people 22, managers 30 and support users 12.

For a social network 80 generated for the support people 22, the system 10 may classify support people based on the problem they are currently working on, with an additional layer showing which of the support people have previous experience 154 with similar problems. This helps a CSR to identify both others working similar issues currently and/or those with more expertise 156. By combining the multiple layers of information questions may be answered, such as which CSRs have expertise in this area and/or are currently working a problem in the same related work area 60.

For management 30, the same system 10 may generate at least one different social network 80, where support people 22 may be grouped by performance 134, ability to articulate 138 a customer's problem, usage of available tools 136 and so on. Managers are provided visualization tools with a variety of views to help with performance management. Managers may also use a similar view as used by the support people and may shift resources based on the types of problems being worked.

Managers 30 may further use these systems 10 to aid in a continual improvement process. The social networks 80 may show a type of problem that fails to be readily resolved, identify the support people 22 that have successfully solved them as the experts 156 and/or the way the type of problem was solved. The managers may use this information to enhance the existing customer support.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A system comprising:
means for facilitating collaboration in a real-time support provider environment of at least two support people with said support provider environment, further comprising:
means for combining at least two of said support people into a temporary group concerned supporting a related work area of said support people;
means for forming-maintaining at least one social network based upon said temporary group to support requests in said related work area; and
means for providing a visualization of said social network.

2. The system of claim 1, wherein the means for combining comprises:
at least one monitor of said support people to determine a work area that said at least two of said support people share to create said related work area.

3. The system of claim 1, wherein the means for forming-maintaining said social network may comprise at least one of
means for generating said social network based upon available information;
means for evolving said social network based upon said available information; and
means for altering said social network based upon said available information.

4. The system of claim 3, wherein said available information includes at least one instance of at least one member of the data type group consisting of a structured information, an unstructured information, a raw data, a derived data and a historical data.

5. The system of claim 4, further comprising at least one of
means for updating by at least one of said support people of said available information; and
means for processing by at least one monitor of at least one instance of at least one member of said data type group to create/update said available information.

6. The system of claim 5, wherein the means for processing by said monitor further comprises at least one of:
at least one natural language processor responding to at least one instance of at least one member of said data type group to at least partly create said available information;
at least one speech to text processor responding to at least one instance of at least one member of said data type group to at least partly create said available information; and
a data aggregator responding to at least part of said available information to send at least part of said available information to at least one member of said natural language processor, said speech to text processor and a classification system.

7. The system of claim 6, wherein the means for forming-maintaining said social network further comprises
said classification system classifying at least part of said available data to generate said social network; and
said classification system classifying said at least part of said available data to stimulate said social network to evolve.

8. The system of claim 1, wherein said visualization of said social network uses at least one grouping of said support people based upon at least one member of the group consisting of at least one estimate of each of said support people,
with said estimate relating to at least one member of the group consisting of a support person's ability to discern a customer's meaning, efficiency in solving a problem, ability to use at least one available tool and ability to articulate a solution of said problem.

9. The system of claim 1, wherein said social network provides at least one classification, wherein said classification is a member of the group consisting of
which of said support people are currently working in said related work area,
which of said support people have previous experience with said related work area and
which of said support people are experts in said related work area.

10. The system of claim 9, wherein the means for providing said visualization further comprises at least one of:
means for providing said visualization to a manager to aid in managing said real-time support provider environment; and
means for inserting said expert into said social network for said related work area.

11. A method comprising the step of:
facilitating collaboration in a real-time support provider environment of at least two support people with said support provider environment, comprising the steps of:
combining at least two of said support people into a temporary group to support a related work area of said support people;
forming-maintaining at least one social network based upon said temporary group to support requests in said related work area; and
providing a visualization of said social network.

12. The method of claim 11, wherein the step of combining further comprises the step of:
monitoring said support people to determine a work area that said at least two of said support people share to create said related work area.

13. The method of claim 11, wherein the step of forming-maintaining said social network comprises at least one of the steps of
generating said social network based upon said available information;
evolving said social network based upon available information; and
altering said social network based upon said available information.

14. The method of claim 13, wherein said available information includes at least one instance of at least one member of the data type group consisting of a structured information, an unstructured information, a raw data, a derived data and a historical data.

15. The method of claim 14, further comprising at least one of the steps of
updating by at least one of said support people said available information; and
processing by said monitor of at least one instance of at least one member of said data type group to create/update said available information.

16. The method of claim 15, wherein the step of processing by said monitor further comprises at least one of the steps of:
processing by at least one natural language processor to at least partly create said available information;
processing by at least one speech to text processor to at least partly create said available information; and
determining by a data aggregator to send at least part of said available information to at least one member of the group consisting of said natural language processor, said speech to text processor and a classification system.

17. The method of claim 14, wherein the step of forming-maintaining said social network further comprises the steps of
classifying by a classification system at least part of said available data to generate said social network; and
classifying by said classification system said at least part of said available data to stimulate said social network to evolve.

18. The method of claim 11, wherein said visualization of said social network uses at least one grouping of said support people based upon at least one member of the group consisting of at least one estimate of each of said support people,
with said estimate relating to at least one member of the group consisting of a support person's ability to discern a customer's meaning, efficiency in solving a problem, ability to use at least one available tool and ability to articulate a solution of said problem.

19. The method of claim 11, wherein said social network for said support people provides at least one classification, wherein said classification is a member of the group consisting of which of said support people are currently working in said related work area, which of said support people have previous experience with said related work area and which of said support people are experts in said related work area.

20. The method of claim 19, wherein the step of providing said visualization further comprises at least one of the steps of:
providing said visualization to a manager to aid in managing said support provider environment; and
inserting said expert into said social network for said related work area.

21. A computer readable memory for implementing said method of claim 11, comprising a program system including at least one of program steps of
facilitating collaboration in said support provider environment of said at least two support people with said support provider environment managed by said manager;
combining said support people into said temporary group concerned with supporting said related work area of said support people;
forming-maintaining said social network based upon said temporary group to support requests in said related work area; and
providing said manager with said visualization of said social network.

22. An installation package configured to install said program system of claim 21, residing in said computer readable memory.

23. A server configured to deliver at least one member of a delivery group consisting of said program system and said installation package of claim 22.

24. A computer configured by at least one member of said delivery group of claim 23 to implement at least part of said method.
